(19) United States
(12) Patent Application Publication
(10) Pub. No.: US 2026/0104253 A1
(43) Pub. Date: Apr. 16, 2026

(54) METHOD, DEVICE AND COMPUTER PROGRAM FOR DETERMINING AN ORIENTATION OF A SAMPLE ON A SAMPLE STAGE

(71) Applicant: Carl Zeiss SMT GmbH, Oberkochen (DE)

(72) Inventors: Frans-Felix Schotsch, Heidelberg (DE); Christof Baur, Darmstadt (DE); Frank Christian Wittnich, Taunusstein (DE)

(21) Appl. No.: 19/419,382

(22) Filed: Dec. 15, 2025

Related U.S. Application Data
(63) Continuation of application No. PCT/EP2024/066371, filed on Jun. 13, 2024.

(30) Foreign Application Priority Data
Jun. 15, 2023 (DE) 102023205623.2

(51) Int. Cl. G01B 21/04

(52) U.S. Cl. CPC G01B 21/045; G01B 2210/56

(57) ABSTRACT

The invention relates to a method for determining an orientation of a sample on a sample stage that is rotatable about an axis of rotation. The method comprises:
a) positioning the sample relatively at a first position; b) rotating the sample through a first rotary angle relative to a height sensor; and c) repeatedly measuring first heights of the sample using the height sensor during the rotation. In the process, steps a) to c) are furthermore performed for at least one second position for the purpose of measuring second heights.

### CROSS-REFERENCE TO RELATED APPLICATIONS

This application is a continuation of and claims benefit under 35 U.S.C. § 120 from PCT Application No. PCT/EP2024/066371, filed on Jun. 13, 2024, which claims priority from German Application No. 10 2023 205 623.2, filed on Jun. 15, 2023, and entitled “Verfahren, Vorrichtung und Computerprogramm zum Bestimmen einer Orientierung einer Probe auf einem Probentisch.” The entire contents of each of these earlier applications are incorporated herein by reference.

### TECHNICAL FIELD

The present invention relates to a method and a device for determining an orientation of a sample on a rotatable sample stage. In particular, the present invention relates to a method and a device for determining an orientation of a sample on a rotatable sample stage, wherein the sample stage is displaceable in substantially horizontal fashion along at least one axis which is substantially parallel to an accommodation surface for accommodating a sample and is rotatable about at least one axis which is substantially perpendicular to the accommodation surface of the sample stage.

### BACKGROUND

As a consequence of the growing integration density in the semiconductor industry, samples such as, e.g., photolithography masks have to image increasingly smaller structures on wafers. Producing the small structure dimensions imaged onto the wafer requires photolithographic masks or templates for nanoimprint lithography with ever smaller structures or pattern elements. The process for producing photolithographic masks and templates for nanoimprint lithography is therefore becoming increasingly more complex and thus more time-consuming and ultimately also more expensive. On account of the tiny structure sizes of the pattern elements of photolithographic masks or templates, faults during mask or template production cannot be ruled out. These must be repaired—whenever possible.

Faults or defects of photolithographic masks, photomasks, exposure masks, or just masks, are often repaired by providing one or more process or precursor gases at the repair location and scanning the defect with an electron beam, for example. The electron beam usually induces a local chemical reaction which, depending on the precursor gas used, results in a local etching process that can be used to remove locally excess material from the photomasks or a template for nanoimprint lithography. Alternatively, in the presence of a corresponding precursor gas, the electron beam induces a local chemical deposition reaction that deposits material locally on the photomask and thus replaces locally missing material of the mask.

A further cause of defects of photolithographic masks is particles that arise for instance as a result of the handling of the mask and deposit on the mask. These particles that disturb the imaging of the mask must likewise be removed from the mask. Disturbing particles can be removed from the photomask firstly with the aid of a local particle beam-induced etching process. Furthermore, it is possible to use a micromanipulator, for example, in the form of a scanning probe microscope, in order to remove excess material, for instance particles present on the mask, from the photomask by use of mechanical processing of the particle.

On account of the increasingly smaller structures of photomasks and the decreasing actinic wavelength with which masks are exposed, ever smaller defects and/or ever smaller particles are having a disturbing effect on the imaging behavior of photomasks. In this regard, in the case of masks for the extreme ultraviolet (EUV) wavelength range, for instance, the actinic wavelength is in a range of approximately 10 nm to 15 nm. Hence there is a need for ever better tools for processing defects of photolithographic masks. Further, this development has the consequence that there are also increased demands in respect of the precision with which identified defects must be able to be homed in on for repair purposes.

Typical devices for particle removal are equipped with a sample stage which can perform a rotational movement through the angle θ in addition to the X-, Y- and/or Z-displacement. The main application of such a rotation is the change in working angle. A height comparison is required for the collision-free displacement of a sample using the sample stage. The height comparison as applied to date in devices for particle removal includes the displacement of the sample stage to different XY-positions and the measurement of the sample surface height. However, this height comparison gives no consideration to changes in height that arise due to a rotational movement.

Known methods for at least a partial determination of a sample orientation on a rotatable sample stage in space comprise methods in which the height of the sample is measured, e.g., at three positions and the height of the sample at other positions can be determined by extrapolation. This three-point measurement must be performed anew following each rotation if the tilt of the sample surface with respect to the sample stage axis of rotation, with which the sample can be rotated, is unknown and/or in the case of an alternative or additional precession. This is time consuming and expensive. Moreover, a comparatively small measurement error can lead to large absolute errors in the determination of the height of other, unmeasured points as a result of extrapolation.

Alternative methods (DE 10 2020 209 638 B3) relate to a rotation of the sample at one point such that the angle-dependent height of a measured point is determined with the result that the sample can be rotated multiple times, e.g., for processing the sample from several angles, without needing to perform the measurement(s) for determining the height anew each time.

However, known methods and devices must determine the orientation of the sample anew for each angle and/or for each displacement. This costs time and results in a low accuracy and a high susceptibility to measurement errors.

A general aspect of the present invention is therefore that of providing a method, a device and a computer program which enable an at least partial improvement in the determination of height.

### SUMMARY

This general aspect is achieved by the aspects described herein. Hereinbelow, the term “substantially” should be interpreted as “within typical construction, measurement and/or manufacturing tolerances.” A first aspect of the invention relates to a method for determining an orientation of a sample on a sample stage. The method comprises the following steps a) to c): a) positioning the sample (relatively) at a first position; b) rotating the sample relatively through a first rotary angle relative to a height sensor; and c) repeatedly measuring first heights of the sample using the height sensor during the rotation. In the process, steps a) to c) are furthermore performed for at least one second position for the purpose of measuring second heights.

In the case of a suitable choice of the rotary angle, e.g. >30° or >45°, e.g., in the range of 30-360°, 45-360°, 90-360°, 120-360° or 180-360° or at approximately 45°, 90°, 120°, 180°, 270° or 360° (in each case with ±5° and/or ±10° deviation), this method can provide heights as a function of the angle θ, the first heights H₁(θ) and the second heights H₂(θ). Mathematically, the two heights H₁(θ) und H₂(θ) define a line through the two points for each measured angle θ, the line being determined by the height H₁(θ) or H₂(θ), and the X- and Y-coordinates of the respective position at which the height measurement was performed, in the plane perpendicular to the height measurement: (X₁, Y₁) or (X₂, Y₂). The full set of coordinates of the two angle-dependent points that define a line in space are (X₁, Y₁, H₁(θ)) and (X₂, Y₂, H₂(θ)). This fully defines the straight line. This is accompanied by the advantageous effect of enabling risk-free processing of the sample along this line without having to fear sample processing tools inadvertently colliding with the sample. This could be a concern and/or possible in the case of unknown heights.

For safety reasons, the known methods and devices make use of tools such as, e.g., sensors, probes, detectors, particle beam sources, etc., at distances from the sample which are greater than the ideal working distance of the respective tool. Nevertheless, this is often required to thus prevent damage to the sample and/or tool on account of an inadvertent collision. Thus the present invention enables safer, faster and more efficient processing of samples, at least along the line determined by the two coordinates described herein.

Step a), positioning the sample (relatively) at a first position, can be implemented in different ways:
The sample can be moved relatively with respect to the height sensor by virtue of the sample and/or the height sensor being moved, e.g., by use of a displacement stage, (e.g., the sample stage), which, e.g., allows separate movements in the X- and Y-directions. Corresponding positioning can be performed once prior to the first heights being measured, with the result that an (X, Y) position can be assigned to this measurement. Following the measurement of the first heights, the sample can be newly positioned at a second position relative to the height sensor prior to the second heights being measured, e.g., during a relative rotation of the sample through the first rotary angle. Thus one height sensor is sufficient for performing a plurality of height measurements at different positions.
If a plurality of height sensors are present, relative positioning of the height sensors with respect to one another may be predetermined or adjustable. The positioning according to the claim can be a one-time step in that case, in which the sample and/or at least one sensor are positioned such that the measurement of the first and second heights at the first and second position, respectively, can be performed in parallel and/or simultaneously. The use of a plurality of height sensors can ensure improved economy in the method since a plurality of measurements can be performed without a displacement in the X-Y-direction, saving time and effort. The use of a plurality of height sensors can also ensure redundancy and hence improved robustness connected therewith.

In this case, positioning generally comprises, in particular, movements in the plane substantially perpendicular to the direction of the height measurement. The X- and Y-coordinates of the position of the height measurement can thus be set in the process.

The sample stage can be displaceable in substantially horizontal fashion along the X- and/or Y-axis which is substantially parallel to an accommodation surface for accommodating a sample and/or can be rotatable about at least one axis which is substantially perpendicular to the accommodation surface of the sample stage.

Step b), rotating the sample through a first rotary angle relative to a height sensor, may generally comprise rotations in the (horizontal) X-Y-plane. Thus the rotation axis of rotation can be substantially perpendicular to the X-Y-plane, i.e., the plane in which the positioning according to step a) may occur. Since the sample might not be arranged perfectly perpendicularly to the axis of rotation, a rotation of the sample about the axis of rotation may yield an angle-dependent height of the sample at the height sensor position, and this angle-dependent height can be recorded in the form of the first and the second heights. In general, the height sensor can be kept stationary (at position (X₁, Y₁) or (X₂, Y₂)) during the rotation of the sample.

Step c), repeatedly measuring the heights of the sample at the position of the height sensor using the height sensor and during the rotation, can be implemented, e.g., continually or incrementally:
In a first example, the sample can be rotated continually from θ=0° to θ=180° (or another rotary angle as described herein), and the height sensor can measure the height of the sample at the height sensor position at uniform angle steps and/or time steps (which e.g., can be converted into an angle). The angle steps Δθ at which the heights of the sample are measured can, e.g., range between 0.001° and 10°, and can be (less than) 0.01°, 0.05°, 0.1°, 0.2°, 0.3°, 0.4°, 0.5°, 0.6°, 0.7°, 0.8°, 0.9°, 1°, 2°, 3°, 4°, 5°, 6°, 7° 8°, 9°, 10° or a value therebetween.
In a second example, the sample can be rotated incrementally through an angle of rotation from θ>0° to θ=180°, e.g., in steps Δθ in the range between 0.001° and 10°, or of (less than) 0.01°, 0.05°, 0.1°, 0.2°, 0.3°, 0.4°, 0.5°, 0.6°, 0.7°, 0.8°, 0.9°, 1°, 2°, 3° 4°, 5°, 6°, 7° 8°, 9°, 10° or a value therebetween. The height sensor can measure the heights of the sample at the height sensor position once or multiple times for each angle or at least for some of the angles.

The direction of rotation can change between successive height measurements for measuring the first and second heights and the rotations connected therewith. For example, the first rotation can be performed from 0° to 360° (clockwise), and the second rotation can be performed from 360° to 0° (anticlockwise). Both rotations can be implemented in the same direction in another example, e.g., in each case from 0° to 360° in the same direction of rotation. The same applies if the measurement of the first and/or second heights comprises a plurality of passes/a plurality of rotations; these can be implemented in the same and/or opposite directions of rotation. If the rotary angle is not 360° or a multiple thereof, then the method may comprise a rotation back to the initial angle (e.g., 0° in this case) such that the next rotation and/or measurement can start from there.

The first and second heights may comprise absolute heights, e.g., in relation to a laboratory system, relative heights, e.g., in relation to the height sensor, to the table on which the device stands and/or to other reference points, and/or relative heights or height changes, e.g., in relation to the height of the sample at an angle, e.g., θ=0° or any other angle.

The rotation (step b) and/or rotary angle-dependent measurement (step c) can be performed once or multiple times for each position. Performing this multiple times may, e.g., reduce the influence of individual measurement errors and thus increase the accuracy and reliability of the measurement.

Measurement methods for measuring height may comprise, e.g., confocal distance measurements, optical interferometry (e.g., using laser light and/or white light), time-of-flight measurements, and/or triangulation. The height sensor or sensors can be configured accordingly.

A plurality of different methods of this type can be applied simultaneously/in parallel or successively for the measurement of the same and/or different heights.

The method described herein can be applied to situations in which the X-Y-Z displacement and the rotation of separate components is determined, and to situations in which combined devices, e.g., a hexapod, determine the X-Y-Z displacement and the rotation.

Further, the plane can also be determined in full by the method if the height of the sample at the location of the axis of rotation is known and can be assumed as constant there over all possible angles of rotation. To this end, the height at the location of the axis of rotation can be used in addition to the first and the second height in this example in order to be able to resort to three points for the complete mathematical determination of the sample plane. For example, the height at the location of the axis of rotation may be known in advance and/or may be determined by a simple height measurement without rotating the sample.

In the method, steps a) to c) can be performed furthermore for at least one additional third position for measuring third (or even further) heights, for example.

In principle, all aspects described herein in relation to the first heights and/or second heights are transferable to the third (or even further) heights and/or the associated measurements, positioning, rotations, further associated devices and/or method steps and/or combinations.

The method presented herein allows the direct measurement of the sample plane in space for the entire angle range of the sample stage, without assuming a model, and thus allows a height comparison for translation and rotation movements. Additional mechanical influences on the sample height are taken into account, e.g., a precession of the axis of rotation, and the accuracy of the height comparison and hence the safety of the sample displacement are increased. The method presented herein is particularly economic in terms of method on account of the data acquisition sequence. The method allows direct and absolute determination of the working plane taking account of all influencing factors, but without requiring the consideration of individual influencing factors. Subsequently, it is possible, e.g., to home in on a multiplicity of locations on the sample, e.g., for processing purposes, and then to readily set the desired working distance precisely in each case.

In an exemplary method, the specified rotary angle of the rotation can be 45° or more.

Hence a sufficiently large angular range can be measured. The first, second and optionally third and further heights can yield good coverage of the relevant angle range even if less than 360° are measured. If only a smaller angular range is of interest, e.g., for planned sample processing steps, it is possible, e.g., to choose the angle of rotation to be smaller in order to save time and effort.

For example, the method may furthermore comprise a determination of a working point-associated height at a working angle θₐ, at least in part on the basis of the first heights and the second heights. If third heights as described herein are measured, the method may furthermore comprise, for example, a determination of a working point-associated height at a working angle θₐ, at least in part on the basis of the first heights, the second heights and the third heights. The same can furthermore be transferred to further (fourth, fifth, sixth, etc.) heights.

The determination on the basis of the height measurements can, e.g., be implemented by mathematical methods and, for example, be output to the system and/or the user. Consequently, this information can be processed at least partly automatically, for example, by setting limits for rotational and positioning ranges which the sample stage must not depart from, for example, in order to avoid collisions between sample and tools. This information can likewise be considered by the user in the further use of the construction.

For example, the method described herein may further comprise a fitting of the first heights and the second heights, preferably as a function of an angle, using a trigonometric function.

For example, the trigonometric function can be h(θ)=h₁·cos(θ−θ₀)−h₀ or h(θ)=h₁·sin(θ−θ₀)−h₀, where h₁ (amplitude of the trigonometric function), θ₀ (phase offset of the trigonometric function) and h₀ (amplitude offset of the trigonometric function) are fitting parameters.

As a result of the greater amount of recorded measurement data and the reduced weighting and/or non-consideration of measurement data outliers in the fitting, a simple and robust interpolation and extrapolation of the height data over the entire sample plane is possible for every angle, even angles which were not explicitly measured.

Further, the method may comprise, e.g., a storing of the fitting parameters, for example, for further processing at a later time. Further, suitable fitting parameter start values which may optionally have been adapted, e.g., on the basis of preceding fitting procedures can be stored. For example, the start value might be the mean value of the corresponding fitting parameters of any desired number of preceding measurements. In an alternative to that or in addition, suitable start values may be manually input by the user. For example, the fitting parameters of previous fitting procedures and/or the mean values thereof, as described herein, could be provided to the user as a reference.

Numerical optimization algorithms, such as, for example, the Levenberg-Marquardt algorithm and/or other algorithms, can be used for fitting the measurement points. Further, it is possible, for example, to use an appropriate metric for quantifying the fitting accuracy, e.g., in order to perform a self-consistency check and/or a validity check. A threshold value above which a self-consistency of the fitting is rejected can be defined at least in part on the basis of the chosen metric. For example, this may be the case if the curve of the first, second, third and/or further heights as a function of the angle of the sample rotation deviates too strongly from a sine or cosine curve. Such a deviation could be based on various faults, for example, a strong precession of the axis of rotation, a wobbling of the sample and/or other mechanical discrepancies.

In one example, the determination of the working point-associated height at a working angle θₐ can be based at least in part on the trigonometric function.

A determination of the working point-associated height at a working angle θₐ on the basis of the trigonometric function is particularly advantageous for the method, by virtue of making the latter more robust, accurate and reliable as a result. Specifically, fitting allows individual measurement value outliers to be compensated. Methods that are unable to compensate such measurement value outliers harbor the significant risk of bringing tools too close to the surface of the sample as a result of an incorrect determination of heights, until there is a collision: Especially if heights are determined on the basis of extrapolations, even small measurement value outliers can result in large errors when determining heights.

In an exemplary method which includes measurement of first, second and third heights, the functional values of the respective fit functions for the first, second and third heights can be output for a selected working angle θₐ. Since the X- and Y-coordinates are also known for all 3 points, the plane is thus determined completely in terms of its position in space in this example. The mathematical description of the plane through these three points also allows determination and/or calculation of the height at any other point in the plane, e.g., for any desired combination of X- and Y-coordinates, by use of extrapolation.

The same can be transferred analogously to a method in which, e.g., only first heights and second heights are measured and hence, for example, the profile of a line through two points can be determined, at least in part on the basis of the trigonometric functions from fitting the first heights and the second heights, rather than an entire plane as described herein.

For example, an exemplary method may furthermore comprise a determination of an angle-dependent slope along a first axis and/or second axis, at least in part on the basis of the first heights and the second heights.

For the working angle θₐ of interest, the corresponding heights can be read from the raw data, for example, if heights were measured for this angle, and/or the functional value of the trigonometric functions can be read from the fitting of the corresponding heights as described herein. This second option can output a height for all possible angles, even for angles which were not measured and for which no raw measurement data are therefore available.

Independently of whether the X-Y-Z coordinates for the points defining the line and/or plane on the sample can be derived from the raw data or the trigonometric fitting functions, it is possible to define one or more slopes relative to the X-Y plane for each working angle θₐ:

For example, the slope between the two points (X₁, Y₁, H₁(θ)) and (X₂, Y₂, H₂(θ)) can be determined as follows: Slope S=ΔH/ΔXY=(H₂(θ)−H₁(θ))/((X₂−X₁)²+(Y₂−Y₁)²)^{1/2}. If it is not only two but three or more points that are known for each angle, a corresponding calculation of the slope can be performed for each pair of points.

If the method comprises the determination of the angle-dependent slope along the first axis and the second axis, the first and the second axis can be substantially perpendicular to one another.

This is advantageous, in particular, since the slopes determined thus are geometrically completely decoupled from one another. For the sake of simplicity, the slopes can be determined substantially along the X-axis and along the Y-axis in particular. This can be advantageous, in particular, if the determined slopes are output to the user and the latter wishes to take into account the information provided for them in the subsequent processing of the sample. Hence, a corresponding method improves the user-friendliness, the comfort and the accuracy of the subsequent work steps.

In one example, the sample can have a substantially flat surface.

The methods described herein are advantageous, in particular, for such samples with substantially flat surfaces. For such samples, a surface unevenness which may influence the measurement values for the first, second, third and/or further heights plays only a subordinate role. Moreover, a corresponding determination of a working position-associated height becomes ever more reliable the flatter the surface is.

In a further example, a normal to the surface of the sample can be at an angle of more than 0° and less than 45° with respect to the axis of rotation of the rotatable sample stage.

If the axis of rotation of the rotatable sample stage is exactly perpendicular to the surface of the sample, then there is no angle-dependent change in height, and the first, second, third and/or further heights as functions of the angle would be essentially constants. In this case, the method described herein could be used for confirming the substantially perpendicular arrangement of the sample surface with respect to the axis of rotation.

If the sample is tilted by, for example, 45° or more relative to the axis of rotation, then an inaccurate and/or faulty attachment of the sample to the sample stage can be assumed, and a reattachment of the sample may in many cases be preferable over an accurate determination of the orientation of the sample surface in space, as described herein. In other examples, such an inaccurate and/or faulty attachment of the sample to the sample stage that a reattachment the sample may be preferred can be already assumed at smaller tilt angles than 45°, e.g., above 30°, above 15° or above 10°. The method described herein can be performed again following a corresponding reattachment of the sample, in order to determine the orientation of the sample in space.

In this case, the sample may comprise or be, e.g., a substrate, by preference a photomask.

The processing accuracy plays a particular role in view of ever smaller structures, especially during the processing of substrates such as photomasks. It may be decisive to use tools at their ideal working distance from the sample. An accurate determination of the sample orientation in space thus is advantageous and optionally even necessary in order to prevent damage to the sample and/or tools during such working steps, especially in such cases.

For example, substrates might comprise, e.g., blanks (e.g., for photomasks), wafers and all rotating/rotatable surfaces of any desired dimension, e.g., of tools or machine tools.

For example, the method may furthermore comprise a determination of a central point, at which an axis of rotation of the sample stage intersects the sample.

If the position of the central point is known by way of an appropriate determination, then this may have a particularly advantageous effect on the other described method steps in respect of increasing the accuracy, robustness and/or reliability of the method.

For example, this allows the height measurement positions to be suitably chosen relative to the central point. For instance, these positions can be distributed approximately uniformly around the central point. This can enable a uniform measurement of the surface in order to improve the accuracy of a subsequent determination of the sample orientation in space.

For example, the determination of the central point may comprise repeated observation of a position of at least one reference marking on the sample while the sample is being rotated. The repeated observation can be implemented like in relation to the repeated measurement in angle steps Δθ as described herein.

For instance, the repeated observation may consist in tracking the path followed by the at least one reference marking on the sample while the sample is being rotated. This path has a circular curve around the central point. Thus, the more accurately the path is tracked, the more accurately the central point can also be determined as a result. If a plurality of reference markings are observed, then the center of all circular paths of all reference markings can be determined, for example, and the central point can be determined on the basis of the centers known thus, for example, by calculating the geometric centroids of the centers of the circular movements.

In theory, these should overlay one another exactly. Thus, deviations of these centers and/or deviations of the paths of the reference markings from circular trajectories can be used for plausibility and self-consistence checks.

For instance, the method may furthermore comprise a lowering of the sample in relation to the height sensor.

In particular, such lowering is advantageous if it is performed before the sample rotation for the height measurement, before the rotation for determining the central point and/or before other rotational and/or translational movements. In such cases, lowering ensures that the sample can be moved and/or rotated risk free, without risking collisions with other elements of the corresponding device.

In an exemplary method, the position of the measurement of the first heights, the second heights and/or third heights may have at least one predetermined distance from a central point at which the axis of rotation of the rotatable sample stage intersects the sample.

If the positions are also separated from one another by at least a predetermined distance, then the points span a sufficiently large area and/or sufficiently long lines therebetween so that measurement errors, etc., can be compensated. This increases the robustness and accuracy of the method.

For example, the positions of the measurements of the first heights, the second heights and/or the third heights may have substantially the same distance from the central point.

The maximum relative distance between the positions of the height measurements is limited by the dimensions of the sample in particular but can be maximized within this frame.

The method may furthermore comprise, e.g., a rotation of the sample to a working angle θₐ.

In particular, it is advantageous to perform this step prior to a further vertical movement of the sample, as described below. If the sample is rotated first, as described herein, it can subsequently be moved vertically without risk.

An exemplary method may furthermore comprise a substantially vertical movement of the sample to a working height, based at least in part on a working point-associated height, as described herein, at a working angle θₐ.

It may be advantageous to perform this step following the rotation to the working angle θₐ. If the sample is rotated first, as described herein, it can subsequently be moved vertically without risk.

The method may furthermore comprise, e.g., a comparison of the first heights, the second heights, the third heights and/or further heights, preferably at least in part on the basis of an amplitude relationship and/or a phase relationship (between the angle-dependent changes in height at the various positions).

Such comparisons can be used for the self-consistency check and/or validity check of the data, which may improve the safety and reliability of the method. If the validity and/or self-consistency is denied in an appropriate test, it is possible, e.g., to output a warning and/or (automatically) stop the method.

For example, if heights are measured at three positions, which are each arranged offset by 90° on a circular trajectory around the central point of the sample, for example, and which hence each also have the same distance from the central point, then it is to be expected from a theoretical point of view that the respective fit functions of the measured heights will have the same amplitude and in each case a phase shift of 90° with respect to one another.

Variations in the arrangement of the positions accordingly also lead to a variation of the amplitude and/or phase relationships between the height curves. For example, if two positions are on opposite sides of the central point, it is to be expected that they are phase shifted by 180° to one another. In another example, it is to be expected that two positions, one twice as far from the central point as the other, will lead to height curves, one of which has an amplitude twice the height of the other. The relationships described herein can be transferred analogously to further variations.

A further aspect of the invention relates to a device for automatically carrying out the method described herein. The device comprises a (e.g., rotatable) sample stage for accommodating a sample, a height sensor and a positioning means for positioning the sample.

Such a device is accompanied by all advantages described herein in relation to the method.

A further aspect of the invention relates to a device having a sample stage for accommodating a sample, a height sensor configured to measure heights of the sample while the sample is being rotated relative to the height sensor, in at least a first and second position relative to the height sensor, a positioning means for positioning the sample relative to the height sensor and a logic unit configured to determine a working point-associated height at a working angle θₐ, at least in part on the basis of the measured heights. This device is also accompanied by all advantages described herein in relation to the method.

Further, an aspect of the invention relates to a computer program comprising instructions to carry out the method steps described herein.

In principle, all aspects described herein in relation to method steps of the method can be transferred to functionalities of a corresponding device and/or to instructions of a corresponding computer program, and vice versa.

### DESCRIPTION OF DRAWINGS

The detailed description that follows describes currently preferred exemplary embodiments of the invention with reference to the drawings, wherein:

FIG. 1 schematically illustrates a skew position of a sample on the sample stage and reproduces an axis of rotation which is not oriented perpendicular to the sample, and therefore results in a wobble movement of the sample during the rotation thereof,

FIG. 2A schematically illustrates the measured region on a sample during the rotation of the sample on the sample stage;

FIG. 2B schematically depicts a possible selection of positions S1, S2 and S3 of the (height) sensor relative to the sample, in particular relative to the axis of rotation;

FIG. 3A depicts a side view of the sample during a wobble movement at a rotary angle θₐ;

FIG. 3B depicts a side view of the sample during a wobble movement at a rotary angle θ_{b}=θₐ+900;

FIG. 3C depicts a side view of the sample during a wobble movement at a rotary angle θ_{c}=θ_{b}+90°;

FIG. 3D depicts a side view of the sample during a wobble movement at a rotary angle θ_{d}=θ_{c}+90°;

FIG. 3E shows a height measurement curve, recorded as represented by way of example and in sections by FIGS. 3A-3D, depicted with an associated trigonometric fit function;

FIG. 4 illustrates a juxtaposition of three height measurement curves, recorded at positions S1, S2 and S3;

FIG. 5 schematically images an exemplary process for sequential angle-dependent height measurement of the sample at three positions S1, S2 and S3, together with a plausibility check; and

FIG. 6 schematically shows an exemplary process for changing the coordinates from location (Xᵢ, Yᵢ, Zᵢ, θᵢ) to location (X_{f}, Y_{f}, Z_{f}, θ_{f}) on the basis of an angle-dependent height measurement.

### DETAILED DESCRIPTION

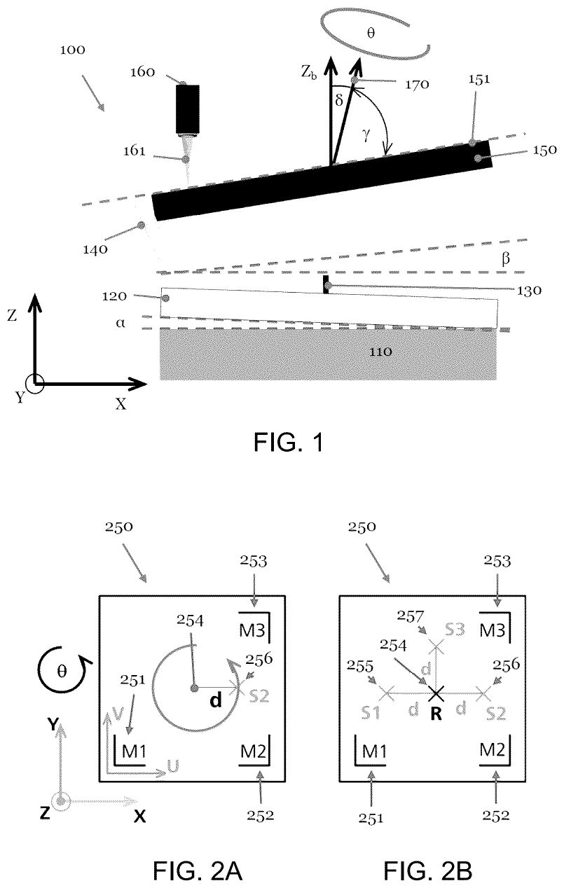

FIG. 1 schematically shows an exemplary embodiment of a device 100 according to the invention. The latter comprises a base plate 110 oriented substantially horizontally (in the x-y-plane). Attached to the latter is a displacement stage 120 which is depicted tilted at an angle α in the x-z plane vis-à-vis the base plate 110 on account of small deviations. The device furthermore comprises a sample stage 140 attached to the displacement stage 120 by use of the pivot 130. In the illustrated example, the sample stage 140 is tilted through the angle β relative to the pivot 130 in the x-z-plane. The sample stage 140 is configured to accommodate a sample 150. As depicted in FIG. 1, the sample 150 might likewise be tilted in relation to the sample stage 140. In particular, the surface 151 of the sample 150 facing the height sensor 160 of the device 100 can be at an angle γ≠90° relative to the axis of rotation 170 of the sample stage 140 and hence to the sample 150. By way of example, the angles α, β and γ are depicted in the x-z-plane in FIG. 1.

However, corresponding tilts may typically occur in different planes. On account of the robust height measurement method, the methods and devices described herein do not depend on the plane in which the tilts occur within the system. The exemplary height sensor 160 of the device 100 directs a (particle) beam 161 at the surface 151 of the sample 150 in order to thus measure the height at the corresponding position. For example, the particles in the particle beam 161 can be photons in the infrared, visible or ultraviolet spectral range, or, e.g., as white light, cover a broad spectral range. For instance, a laser sensor, confocal-chromatic sensor, laser time-of-flight sensor, interferometer, capacitive distance sensor or eddy current sensor can be used as height sensor 160. Other height sensors can be used in other exemplary embodiments.

In this context, the x-y-plane is defined as the plane in which the sample 150 can be displaced together with the displacement stage 120. Thus, the x-y-plane corresponds to the plane of the base plate 110 in the example of FIG. 1. However, the concepts described herein likewise apply if the plane of the base plate deviates from the x-y-plane, in which the sample 150 can be displaced with the displacement stage 120.

It is emphasized that, in general, it is also possible to position and/or rotate the height sensor as an alternative to that or in addition.

In particular, FIG. 1 illustrates various possibly occurring deficiencies or defects of various components of the sample stage 140. As depicted in FIG. 1, the displacement stage 120, which moves the sample stage 140 in the x-direction, may be tilted through an angle α vis-à-vis the base plate 110. Further, the displacement stage 120 might be tilted through an angle β vis-à-vis the sample stage 140. These two inadequacies result in an oblique or skew position of the sample 150. A detailed explanation has already been given above of how a skew position of the sample 150 can be determined and can be taken into account when carrying out translational movements of the sample stage 140.

However, an oblique position of the sample 150 alone does not result in a wobble movement of the sample 150 as long as the axis of rotation 170 of the sample stage 140 is aligned perpendicular to the sample 150 or to the surface 151 thereof. By contrast, an orientation of the axis of rotation 170 that deviates from the perpendicular to the sample 150 results in a change in height during the rotation of the sample 150 by the sample stage 140. A change in height of the sample 150 during the rotation is referred to hereinafter as a wobble movement of the sample 150. The change in height of the sample 150 comprises the change in the z-position of the sample at a measurement position in the x-y-plane.

FIG. 1 schematically shows that the axis of rotation 170 is at an angle δ in relation to the z-axis of the base plate 110. However, the angle deviation 6 does not result in a wobble movement of the sample 150 during the rotation thereof as long as the axis of rotation 170 is oriented perpendicularly to the sample 150 (i.e., γ=90°, for example, holds true). In the exemplary diagram, the angle γ measuring the angle between the sample surface 151 and the orientation of the axis of rotation 170 has a numerical value that deviates from 90°. The angle γ≠90° results, however, in a change in height during the rotation of the sample 150 about the axis of rotation 170, which change in height is detected by the particle beam 161 of the height sensor 160. FIG. 1 illustrates the complex way skew layers of the individual components are overlayed on one another. From this, it is evident how advantageous the method according to the invention is, as this manages without explicit listing of the contributing skew layers and instead can easily, robustly and quickly establish/determine the orientation of the surface 151 of the sample 150 in space in angle-dependent fashion. For the sake of clarity, the angles α, β and δ are depicted much larger than what would be expected in many cases.

FIG. 2A schematically shows the measured region on a sample 250 during the rotation of the sample 250 on the sample stage. For orientation purposes, the exemplary sample has three markings M1 251, M2 252 and M3 253, preferably arranged at right angles to one another as indicated.

The portion (circular arrow) measured by the particle beam when the sample 250 is rotated about the axis of rotation 254 is shown in FIG. 2A for a position S2 256 at which the height sensor directs its particle beam (both not shown here). Point S2 256 is separated from the axis of rotation 254 at a distance d, and so the circular curve of the height measurement on the sample comprises points located on a circle with radius d around the center 254.

FIG. 2B schematically shows a possible selection of positions S1 255, S2 256 and S3 257 of the height sensor relative to the sample 250, in particular relative to the axis of rotation 254. The positions of the points S1 255, S2 256 and S3 257 are chosen such that these all are at a distance d from the axis of rotation 254. Points S1 255 and S2 256 are spaced apart from one another by 2d on opposite sides of the axis of rotation 254, at the coordinates (x,y)s₁=(x_{R}−d,y_{R}) and (x,y)s₂ (x_{R}+d,y_{R}), where point R, at which the axis of rotation 254 intersects the sample 250, has the coordinates (x_{R},y_{R}). In the example of FIG. 2B, the position of S3 257 (x,y)s₃=(x_{R},y_{R}+d) is chosen such that the connection between R 254 and S3 257 is perpendicular to the axis through S1 255, R 254 and S2 256, and the distance between R 254 and S3 257 is also d. Other combinations of positions are possible, for example it is possible to choose other, more and/or fewer positions.

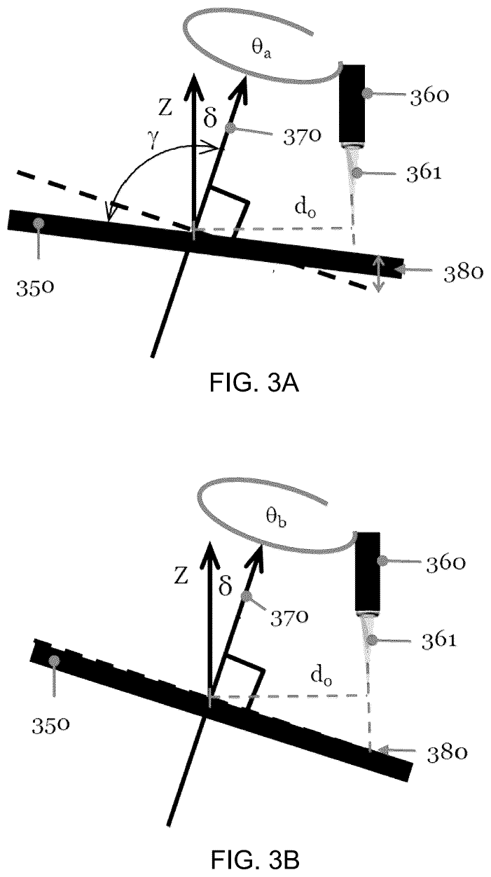

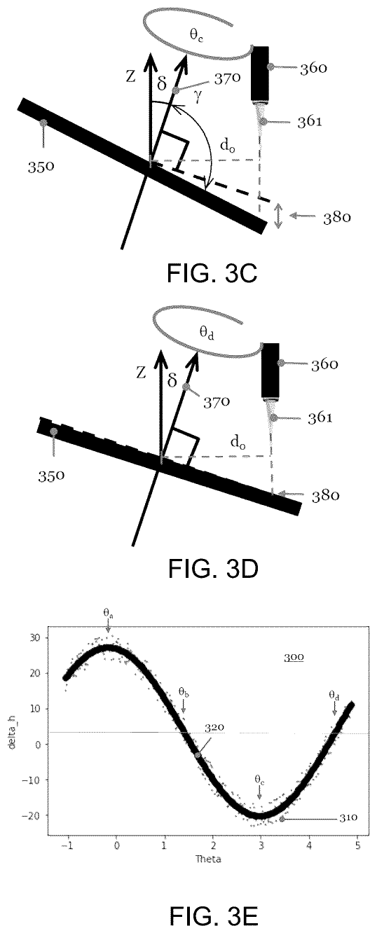

FIGS. 3A-3D show a side view of a sample 350 during a wobble movement about an axis of rotation 370 at different rotary angles in 90° steps: θₐ (FIG. 3A), θ_{b}=θₐ+90° (FIG. 3B), θ_{c}=θ_{b}+90° (FIG. 3c) and θ_{d}=θ_{c}+90° (FIG. 3D). The height measuring position is separated from the axis of rotation by do.

In FIG. 3A, the sample 350 is in a state in which it is located at the measurement position closest to a horizontal alignment in relation to the (particle) beam 361 of the height sensor 360. The height 380 of the measured point on the sample 350, relative to the point of intersection between the (particle) beam 361 and the plane depicted using dashed lines and extending perpendicular to the axis of rotation 370, is therefore at a maximum at θₐ.

In FIG. 3B, the sample 350 is in a state in which it is exactly in the plane depicted using dashed lines, with the result that the height 380, relative to the point of intersection between the (particle) beam 361 and the plane depicted using dashed lines, of the measured point on the sample 350 is therefore zero at θ_{b}.

In FIG. 3C, the sample 350 is in a state in which it is inclined the most against a horizontal alignment in relation to the (particle) beam 361 of the height sensor 360. The height 380, relative to the point of intersection between the (particle) beam 361 and the plane depicted using dashed lines, of the measured point on the sample 350 is therefore at a minimum at θ_{c}.

In FIG. 3D, the sample 350 is back in a state in which it is exactly in the plane depicted using dashed lines, with the result that the height 380, relative to the point of intersection between the (particle) beam 361 and the plane depicted using dashed lines, of the measured point on the sample 350 is therefore zero at θ_{d}.

FIGS. 3A-3D only show sections in the x-z-plane. In the y-z-plane (not shown here) there are analogous tilts and height differences, phase-shifted accordingly by 90°.

FIG. 3E shows a height measurement curve h(θ, dₒ) 300 as a function of the rotary angle θ, specified in radians, consisting of individual measurement error-afflicted measurement values 310, recorded as depicted by way of example and in section by FIGS. 3A-3D, together with an associated trigonometric fit function 320. The change in height or the height profile 300 is represented in micrometers. The points 310 represent measurement points of the height sensor during a rotation process. The fit function 320 of FIG. 3E depicted by way of example is h(θ)=h₁·cos(θ−θₐ)−h₀. In an alternative to that, e.g., a sine fit function can likewise be used. Numerical optimization algorithms, such as the Levenberg-Marquardt algorithm, for example, can be used for fitting the measurement points 310. The parameters θₐ, h₁ and h₀ are determined as a result of fitting the measurement data 310 to the function indicated above.

For example, the height of the sample at the position of the measurement can be determined for any desired working angle on the basis of this one measurement 300. A second and a third height measurement 300 at a second and third position disclose a second and a third height, respectively, for every possible angle, and these make it possible to mathematically determine a line on the sample (for two known heights) or the entire surface of the plane (for three known heights).

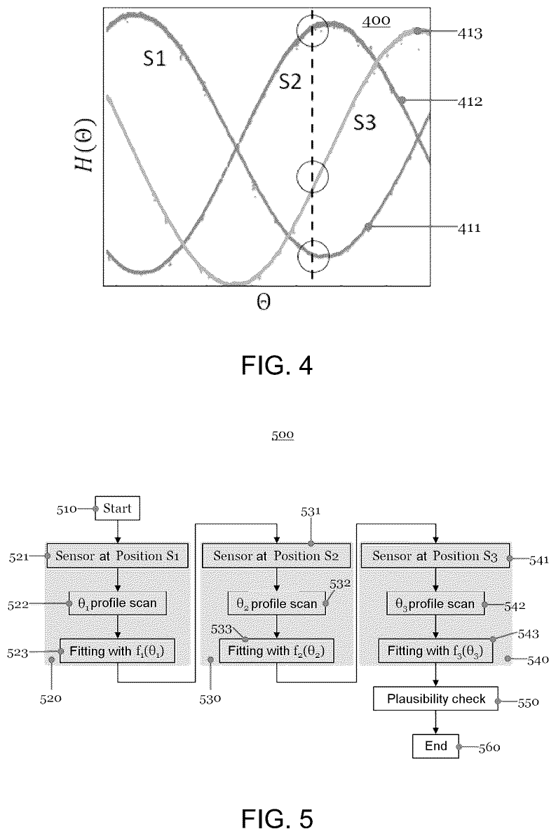

FIG. 4 shows a juxtaposition 400 of three height measurement curves 411, 412, 413, recorded at the positions S1, S2 and S3 as depicted in FIG. 2B. These are referred to below also using the reference signs of FIG. 2B. Each individual height measurement curve h(θ) 411, 412, 413 depicted is recorded as described in relation to FIGS. 3A-3E. If the measurement positions S1 255, S2 256 and S3 257 are at the same distance d from the axis of rotation 254, then all three positions are located on a common circular trajectory with radius d around the central point on the sample. The points on the sample measured by the height sensor or sensors therefore extend along this circular trajectory and carry out a wobble movement with an amplitude of equal size.

Within the scope of the measurement accuracy, this theoretically results in the same amplitude of the change in height/height measurement curves h(θ) 411, 412, 413, expressed by the same fitting parameters h_{1,s1}≈h_{1,s2}≈h_{1,s3}. For example, this amplitude relationship can be used for plausibility checks as described herein. The same applies to the 90° phase shift which is to be expected between the height measurement curves h(θ) 411, 412, 413 for the measurement positions S1 255, S2 256 and S3 257 as in FIG. 2B. Using three known heights at three positions as a basis, the change in height at any desired point of the sample can be determined for each angle by a linear interpolation or a linear extrapolation of the height measurement curves h(θ) 411, 412, 413, wherein the height profiles 411, 412, 413 describe the height of the sample as a function of the rotary angle θ and distance d from the axis of rotation: Using the definition Pᵢ=(Xᵢ, Yᵢ, Hᵢ(θ) (for three points: i=1, 2, 3 in this example), the plane R can be described in full mathematically by R=P₁+n·(P₂−Pᵢ)+m·(P₃−Pᵢ) (with n, m ε [symbol] ) if the three points P₁, P₂ and P₃ are not precisely on one line.

FIG. 5 schematically shows an exemplary process 500 for sequential angle-dependent height measurement of the sample at three positions S1, S2 and S3, together with a plausibility check 550.

In a superordinate division, the process 500 can be subdivided into a start 510, three blocks for recording height measurement curves h(θ) 520, 530, 540, a plausibility check 550 and an end 560 of the process 500.

The first block 520 for recording height measurement curves h(θ) essentially contains positioning the height sensor at the position S1 521, performing a 01 profile scan 522 comprising a rotation of the sample and the recording of height measurement values, and a fitting of the measurement values recorded thus to a fit function f₁(θ₁).

The second block 530 essentially contains positioning the height sensor at the position S2 531, performing a θ₂ profile scan 532 comprising a rotation of the sample and the recording of height measurement values, and a fitting 533 of the measurement values recorded thus to a fit function f₂(θ₂).

The third block 540 essentially contains positioning the height sensor at the position S3 541, performing a θ₃ profile scan 542 comprising the rotation of the sample and the recording of height measurement values, and a fitting 543 of the measurement values recorded thus to a fit function, fitting with f₃(θ₃).

Essentially the second block 530 and the third block 540 only represent a repetition of the steps of the first block 520 at a different position. For example, other methods according to the invention may also comprise only two such blocks, four or more such blocks 520, 530, 540 and/or blocks 520, 530, 540 with more or fewer partial steps. In other embodiments, fitting 523, 533, 543 might also be implemented after all blocks 520, 530, 540 have been implemented.

As an alternative to that or in addition, it is also possible to rotate the height sensor rather than the sample. For example, the measurement points S1, S2, S3 can correspond to those of FIG. 2B.

The plausibility check 550 can consider the measurement values and/or fitting parameters.

It is possible to perform plausibility checks for all blocks 520, 530, 540 on an individual basis, for example as an additional partial step of one or more blocks 520, 530, 540. For example, the fit quality (e.g., coefficient of determination of the regression R²) can be used to assess whether the fit function describes the measurement values sufficiently well. For instance, an R² threshold value may be predetermined, above which a fit function is accepted by the system. In addition to that or as an alternative, there can be plausibility checks 550 which check the consistency between the height measurement curves, for example, on the basis of theoretically expected amplitude and/or phase relationships between the at least two height measurement curves and/or the corresponding fit functions, and, e.g., output a warning above a predetermined deviation value.

In devices with two or more height sensors, two or more blocks 520, 530, 540 can be performed in parallel (simultaneously).

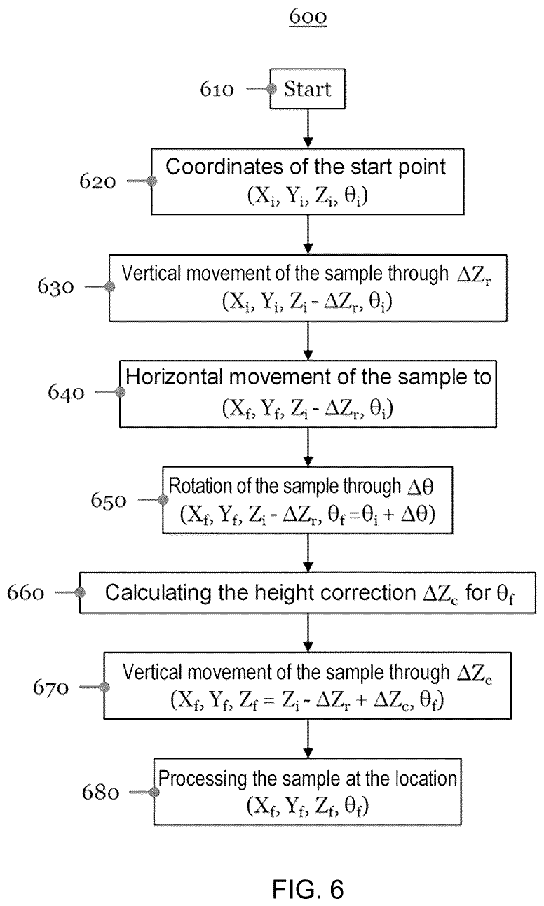

FIG. 6 schematically shows an exemplary process 600 for changing the coordinates from location (Xᵢ, Yᵢ, Zᵢ, θᵢ) to location (X_{f}, Y_{f}, Z_{f}, θ_{f}) on the sample on the basis of an angle-dependent height measurement. The exemplary process 600 illustrated is subdivided into the following partial steps: a start 610 of the process 600, for which the coordinates of the start point are (Xᵢ, Yᵢ, Zᵢ, θᵢ) 620, a vertical movement of the sample through ΔZᵣ to the location (Xᵢ, Yᵢ, Zᵢ−ΔZᵣ, θᵢ) 630, a horizontal movement of the sample to the location (X_{f}, Y_{f}, Zᵢ−ΔZᵣ, θᵢ) 640, a rotation of the sample through Δθ to (X_{f}, Y_{f}, Zᵢ−ΔZᵣ, θ_{f}=θᵢ+Δθ) 650, a calculation of the height correction ΔZ_{c} for θ_{f} 660, a vertical movement of the sample through ΔZ_{c} (X_{f}, Y_{f}, Z_{f}=Zᵢ−ΔZᵣ+ΔZ_{c}, θ_{f}) 670 and a processing of the sample at the (target) location (X_{f}, Y_{f}, Z_{f}, θ_{f}) 680.

The vertical movement of the sample through ΔZᵣ to the location (Xᵢ, Yᵢ, Zᵢ−ΔZᵣ, θᵢ) 630 in the depicted process 600 represents a safety measure which prevents the sample, whose orientation in space is generally not known at this time, from colliding with, e.g., the height sensor during a translational movement and/or a wobble movement of its rotation. The sample stage is lowered to a safe height in order to preclude collisions during the subsequent movements. Therefore, the sample can be displaced without risk in step 640 and/or rotated without risk in step 650 following step 630, without the risk of collisions as described herein. The height correction for this new working position is calculated 660 following the horizontal displacement 640 and the rotation 650, as described in the previous paragraph. The sample stage is raised back to the working height 670 in the last step using this height correction.

The height compensation described herein allows an automated change in the working angle (e.g., from θᵢ to θ_{f} in FIG. 6). The same working region as before, albeit from different angle, is observed following the process 600 if the system comprises equipment for observing a working region on the sample, e.g., a scanning electron microscope.

What is claimed is:

1. A method for determining an orientation of a sample on a sample stage, the method including the following steps:
a) positioning the sample at a first position relative to a height sensor;
b) rotating the sample through a first rotary angle relative to the height sensor; and
c) repeatedly measuring first heights of the sample using the height sensor during the rotation;
with steps a) to c) furthermore being performed for at least one second position for the purpose of measuring second heights.

2. The method of claim 1, wherein steps a) to c) are furthermore performed for at least one additional third position for the purpose of measuring third heights.

3. The method of claim 1, wherein the specified rotary angle of the rotation is 45° or more.

4. The method of claim 1, furthermore comprising a determination of a working point-associated height at a working angle θa, at least in part on the basis of the first heights and the second heights.

5. The method of claim 4, furthermore comprising a fitting of the first heights and the second heights, as a function of an angle, using a trigonometric function.

6. The method of claim 5, wherein the determination of the working point-associated height at a working angle θa is based at least in part on the trigonometric function.

7. The method of claim 1, furthermore comprising a determination of an angle-dependent slope along a first axis and/or second axis, at least in part on the basis of the first heights and the second heights.

8. The method of claim 6, furthermore comprising a determination of an angle-dependent slope along a first axis and/or second axis, at least in part on the basis of the first heights and the second heights.

9. The method of claim 7, wherein the angle-dependent slope is determined along the first axis and second axis; and
wherein the first axis and second axis are substantially perpendicular to one another.

10. The method of claim 1, wherein the sample has a substantially flat surface.

11. The method of claim 10, wherein a normal to the surface is at an angle of more than 0° and less than 45° with respect to the axis of rotation of the rotatable sample stage.

12. The method of claim 1, wherein the sample comprises a substrate.

13. The method of claim 1, wherein the sample comprises at least one of: a blank, a wafer, a surface of a tool.

14. The method of claim 1, furthermore comprising a determination of a central point at which an axis of rotation of the sample stage intersects the sample.

15. The method of claim 14, wherein the determination of the central point comprises repeated observation of a position of at least one reference marking on the sample while the sample is being rotated.

16. The method of claim 1, furthermore comprising a lowering of the sample in relation to the height sensor.

17. The method of claim 14, wherein the measurement position for the first heights and/or for the second heights has at least one predetermined distance from a central point at which the axis of rotation intersects the sample.

18. The method of claim 17, wherein the measurement positions for the first heights and for the second heights have substantially the same distance from the central point.

19. The method of claim 1, furthermore comprising a rotation of the sample to a working angle θa.

20. The method of claim 4, furthermore comprising a substantially vertical movement of the sample to a working height, based at least in part on a working point-associated height at a working angle θa.

21. The method of claim 1, furthermore comprising a comparison of the first heights and the second heights, at least in part on the basis of an amplitude relationship and/or a phase relationship.

22. A device for automatically carrying out the method of claim 1, the device comprising:
a sample stage for accommodating a sample;
a height sensor; and
a positioning means for positioning the sample relative to the height sensor.

23. A device, comprising:
a sample stage for accommodating a sample;
a height sensor configured to measure heights of the sample while the sample is being rotated relative to the height sensor, in at least a first and second position relative to the height sensor;
a positioning means for positioning the sample relative to the height sensor; and
a logic unit configured to determine a working point-associated height at a working angle θa, at least in part on the basis of the measured heights.

24. The device of claim 23, wherein the sample is a wafer and the sample stage is a wafer stage, or the sample is a photomask and the sample stage is a photomask stage.

25. A computer-readable storage medium on which a computer program is stored, the computer program comprising instructions for carrying out the method steps according to claim 1.
